(19) United States
(12) Patent Application Publication
(10) Pub. No.: US 2007/0280161 A1
(43) Pub. Date: Dec. 6, 2007

(54) HANDOVER OF A BACKWARD-COMPATIBLE MOBILE UNIT

(76) Inventors: ASHOK RUDRAPATNA, Basking Ridge, NJ (US); Jialin Zou, Randolph (CA)

Correspondence Address: WILLIAMS, MORGAN & AMERSON, 10333 RICHMOND, SUITE 1100, HOUSTON, TX, 77042, US

(21) Appl. No.: 11/421,874

(22) Filed: Jun. 2, 2006

(51) Int. Cl. H04Q 7/00

(52) U.S. Cl. 370/331

(57) ABSTRACT

The present invention provides a method of wireless communication involving at least one first carrier operating according to a first system type and at least one second carrier operating according to a second system type is provided. The method may include determining that a mobile unit is to be handed over between a first carrier operating according to the first system type and a second carrier operating according to the second system type based on a loading of at least one of the first and second carriers.

### BACKGROUND OF THE INVENTION

1. Field of the Invention

This invention relates generally to communication systems, and, more particularly, to wireless communication systems.

2. Description of the Related Art

The coverage area of a wireless communication system is typically divided into a number of cells, which may be grouped into one or more networks. Base stations associated with the cells provide wireless connectivity to mobile units in the cell or in a sector of the cell. The mobile units may include devices such as mobile telephones, personal data assistants, smart phones, Global Positioning System devices, wireless network interface cards, desktop or laptop computers, and the like. Mobile units located in each cell may access the wireless communications system by establishing a wireless communication link, often referred to as an air interface, with a base station associated with the cell. Information may be transmitted over the air interface using a carrier, such as a high frequency radio sinusoid waveform that is modulated based on the information to be transmitted by the carrier. Each base station may support more than one carrier and mobile units located at a specific position may be able to access carriers provided by more than one base station.

Mobile units are frequently handed off from one base station to another and/or from one carrier to another. For example, a mobile unit may roam through coverage areas of several cells and therefore may be handed off from one base station to another as the mobile unit travels through the associated cells or sectors. For another example, the coverage area associated with a base station and/or a carrier may vary due to changing environmental conditions, changing network configurations, and the like. Accordingly, even stationary mobile units may be handed off to another base station, e.g., if the channel quality provided by the current serving base station deteriorates. Handovers may be hard, i.e., the old connection to the serving base station is broken before the new connection to a target base station is made, or soft, i.e., the new connection to the target base station is made before the old connection to the serving base station is broken. Thus, a mobile unit in soft handover maintains concurrent connections with more than one base station during the handover.

Evolving wireless communication systems frequently include cells that provide wireless connectivity using carriers that operate according to different revisions or versions of the relevant wireless communication standards. For example, a conventional wireless communication system may include some base stations that operate according to Revision-B and/or Revision-C of the CDMA2000 EVDO standards. Revision-C is a later revision than Revision-B and so mobile units that support Revision-B may or may not also support Revision-C, and vice versa. When a mobile unit is handed off in a conventional wireless communication system, the mobile unit will attempt to hand off to a carrier that operates according to the most recent revision supported by the mobile unit. For example, a mobile unit that supports Revision-C will always attempt to handoff to a carrier that also operates according to Revision-C.

Handoff to carriers that operate according to the most recent revision has a number of advantages, such as permitting the mobile unit to use the improved services provided by the most recent revision. However, this approach also has a number of disadvantages. For example, many mobile units may attempt to handoff to carriers that operate according to the most recent revision, at least in part because of the aforementioned advantages to using these carriers. Consequently, these carriers may be overloaded or unavailable. The overall quality of service provided to mobile units transmitting over carriers that operate according to the most recent revision may be degraded when these carriers are overloaded. Furthermore, scarce radio resources may be wasted when additional mobile units attempt to handoff to the overloaded or unavailable carriers.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for wireless communication involving at least one first carrier operating according to a first system type and at least one second carrier operating according to a second system type is provided. The method may include determining that a mobile unit is to be handed over between a first carrier operating according to the first system type and a second carrier operating according to the second system type based on a loading of at least one of the first and second carriers.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a wireless communication system, in accordance with the present invention;

FIG. 2 conceptually illustrates one exemplary embodiment of an overhead message, in accordance with the present invention; and

FIG. 3 conceptually illustrates one exemplary embodiment of a method of handover for a mobile unit, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

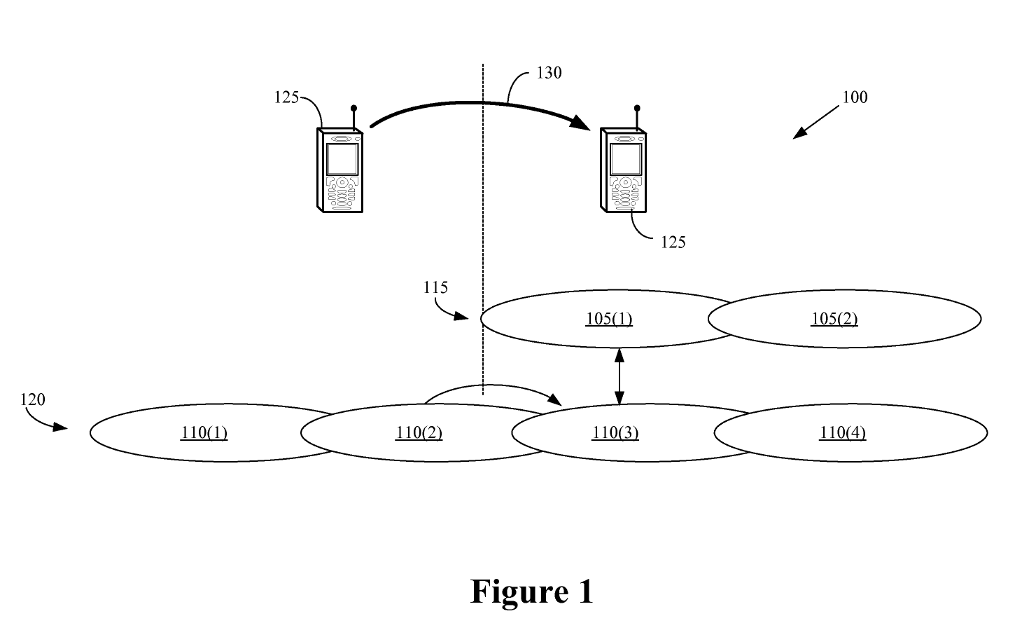

FIG. 1 conceptually illustrates a first exemplary embodiment of a wireless communication system 100. In the illustrated embodiment, the wireless communication system 100 provides wireless communication to a plurality of geographic areas or cells 105(1-2), 110(1-4). The numerical indices may be dropped when referring to the cells 105, 110 collectively. However, the numerical indices (1-2), (1-4) may be used to indicate individual cells 105, 110 and/or subsets of the cells 105, 1 10. This numbering convention may be applied to elements depicted in other figures and distinguished by different numerical indices. Persons of ordinary skill in the art having benefit of the present disclosure should appreciate that the wireless connectivity may be provided to the cells 105, 110 using one or more base stations, base station routers, access points, and the like, as well as controllers such as radio network controllers, although these entities and/or devices are not shown in FIG. 1. Persons of ordinary skill in the art having benefit of the present disclosure should also appreciate that the number of cells 105, 110 shown in FIG. 1 is intended to be illustrative and not to limit the present invention.

The cells 105, 110 are separated into layers 115, 120 that implement different system types. In one embodiment, the system types implemented in the layers 115, 120 are distinguished by the standard or protocol revision used to provide wireless connectivity over the carriers supported by the cells in the layers 115, 120. For example, layer 115 may operate according to Revision-C of the EVDO standard and layer 120 may operate according to Revision-B of the EVDO standard. As used herein, the terms “standard or protocol revision” will be understood to refer to revisions of a wireless communication standard or protocol that are implemented in (or supported by) successive generations of wireless communication equipment. One characteristic of a standard or protocol revision is that wireless communication equipment that was originally designed only to support an earlier, or legacy, revision is typically not able to communicate using later (or most recent) revisions of the standard or protocol. In contrast, wireless communication equipment that is designed to support later revisions may also be able to support legacy revisions of the standard or protocol, e.g., wireless communication equipment may be backwards compatible with legacy revisions of the standards or protocols.

The system types implemented in the layers 115, 120 may also be distinguished by frequencies of the carriers used provide wireless connectivity and/or the radio access technology used to provide wireless connectivity. For example, in a wireless communication system 100 that operates according to EVDO Rev-B standards and/or protocols, wireless connectivity may be provided to the cells 105 using a first carrier frequency and to the cells 110 using a second carrier frequency. For another example, wireless connectivity may be provided to the cells 105 according to UMTS standards and/or protocols and wireless connectivity may be provided to the cells 110 according to EVDO Rev-C standards and/or protocols.

The wireless communication system 100 provides wireless connectivity to one or more mobile units 125. Only one mobile unit 125 is shown in the illustrated embodiment, however, persons of ordinary skill in the art having benefit of the present disclosure should appreciate that any number of mobile units 125 may operate within the wireless communication system 100. Persons of ordinary skill in the art having benefit of the present disclosure should also appreciate that the mobile units 125 may be referred to using other terms of art such as “user equipment,” “mobile stations,” “subscriber units,” “subscriber stations,” and the like. Exemplary mobile units 125 may include, but are not limited to, devices such as mobile telephones, personal data assistants, smart phones, Global Positioning System devices, wireless network interface cards, desktop or laptop computers, and the like.

The mobile unit 125 may be capable of communicating with cells 105, 110 in one or both of the layers 115, 120. For example, the mobile unit 125 may be a backwards-compatible Rev-C-EVDO device that is capable of communicating using carriers provided by cells 105 according to Revision-C of the EVDO standard and carriers provided by cells 110 according to Revision-B of the EVDO standard. For another example, the mobile unit 125 may be a Rev-B-EVDO device that is not capable of communicating using carriers provided by cells 105 according to Revision-C of the EVDO standard, but is capable of communicating using carriers provided by cells 110 according to Revision-B of the EVDO standard. In the illustrated embodiment, the mobile unit 125 is shown at a location that is associated with the overlapping coverage areas of the cells 105(1), 110(3). The mobile unit 125 may therefore be handed off between carriers provided by the cells 105(1), 110(3).

A controller such as a radio network controller (not shown) may determine whether or not to hand off the mobile unit 125 based upon loads associated with the carriers provided by the cells 105(1), 110(3). In one embodiment, the handoff decision may be used to support grade of service (GoS) in the wireless communication system 100. For example, the cells 105 may support a most recent revision of a standard or protocol, such as Revision-C, and the cells 110 may support a legacy revision of the standard or protocol, such as Revision-B. If the carriers in the cell 105(1) are heavily loaded or overloaded, but additional emergency calls and/or high-priority calls are attempting to access these carriers, then non-emergency and/or lower priority calls currently communicating using these carriers could be handed off to carriers in the cell 110(3). The decision to downgrade one or more lower priority calls may also be based on the quality of service required for the emergency calls and/or high-priority calls, as well as a projected loading of the carriers after admission of the priority calls. Alternatively, if the mobile unit 125 has a connection using a carrier in the cell 110(3) but the loading of carriers in the cell 105(1) is relatively low, the mobile units 125 may be handed off from the cell 110(3) to the cell 105(1).

Handover of the mobile unit 125 between carriers that operate according to different system types, such as different revisions of a standard or protocol, may require that the mobile unit 125 changes a personality or profile. As used herein and in accordance with usage in the art, the term “personality” will be understood to refer information and/or algorithms stored in and/or used by the mobile unit 125 to establish communications over a carrier according to the standards and/or protocols implemented by the carrier. For example, the personality of the mobile unit 125 may include configuration information used to configure the mobile unit 125 to communicate according to the standards and/or protocols implemented by the carrier, such as Revision-B and/or Revision-C. The personality may be implemented in hardware, firmware, software, or any combination thereof.

In one embodiment, a handover from the cell 110(3) to the cell 105(1) may be triggered by handover from the cell 110(2) to the cell 110(3). For example, the mobile unit 125 may initially be associated with the cell 110(2). The mobile unit 125 may therefore access the wireless communication system 100 via the cell 110(2) and receive information from the wireless communication system 100 via the cell 110(2), e.g., according to Revision-B of the EVDO standard. The mobile unit 125 may then move into a geographic area or sector served by the overlaid carriers 105(1), 110(3). Performing a hard handover from the cell 110(2) that operates according to the first system type to the cell 105(1) that operates according to the second system type may result in a performance degradation compared to performing a soft handover. Accordingly, a soft handover may first be used to hand over the mobile unit 125 from the cell 110(2) to the cell 110(3). The soft handover is followed by handover of the mobile unit 125 from the cell 110(3) to the cell 105(1), which may occur after the mobile unit 125 has moved towards the center of the cell 110(3) and so the performance degradation may be reduced.

In one embodiment, the mobile unit 125 may receive one or more overhead messages provided by the default carrier 110(3) (i.e., the carrier that is currently serving the mobile unit 125) prior to (or during) the handover. The overhead message(s) include a list of the carriers and the system types associated with these carriers. For example, the overhead message may include a list of one or more Rev-C-compatible carriers and one or more Rev-B-compatible carriers. In one embodiment, the overhead message may also include information indicating whether or not the listed carriers are available to given priority classes of mobile units, e.g., the list may indicate whether the carriers are currently overloaded.

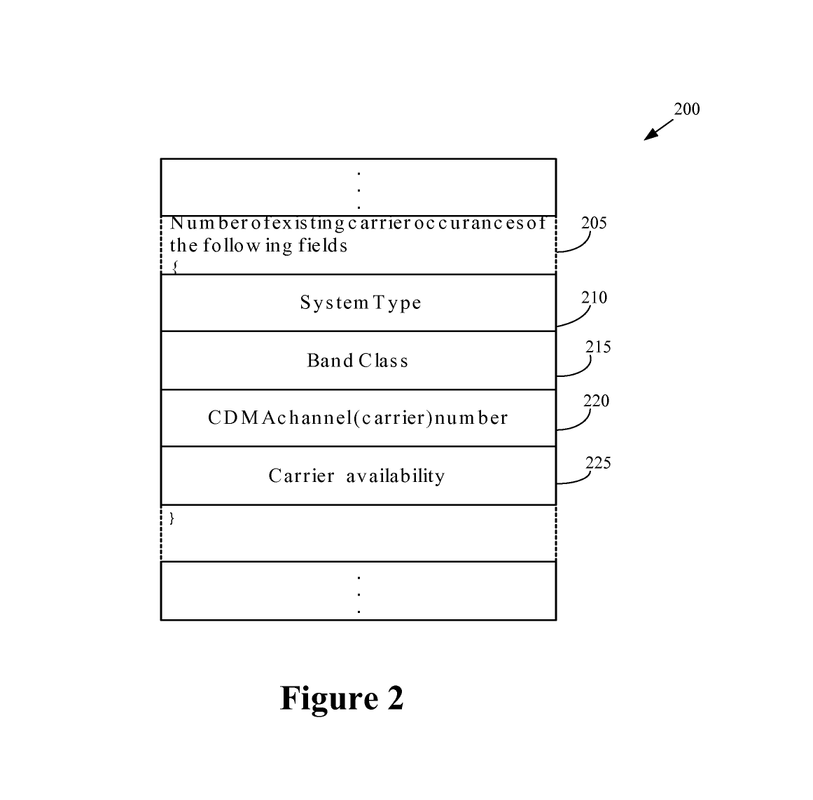

FIG. 2 conceptually illustrates one exemplary embodiment of an overhead message 200. In the illustrated embodiment, the overhead message 200 includes a field 205 that indicates the total number of carriers in the sector that receives the overhead message 200. The overhead message 200 also includes a set of fields 210, 215, 220 for each of the existing carriers. The fields 215, 220 indicate the band class of the carrier and the CDMA channel or carrier number of the carrier, respectively. The field 210 indicates the system type of the associated carrier. For example, the field 210 may indicate that the associated carrier operates according to either Revision-B or Revision-C of the EVDO standard. However, as discussed above, the fields 210 may also indicate other system types associated with the carrier. In one embodiment, the overhead message 200 includes a field 225 that indicates availability of the associated carrier. For example, the field 225 may include information indicating whether the carrier is overloaded. Alternatively, the field 225 may include information indicating a current loading of the carrier with different levels of availability associated with different priority classes of mobile units. Instead of field 225, another possible way to convey the carrier availability information to mobile units is to define a field, such as an AccessHashingChannelMask field, in the DO overhead message for this purpose.

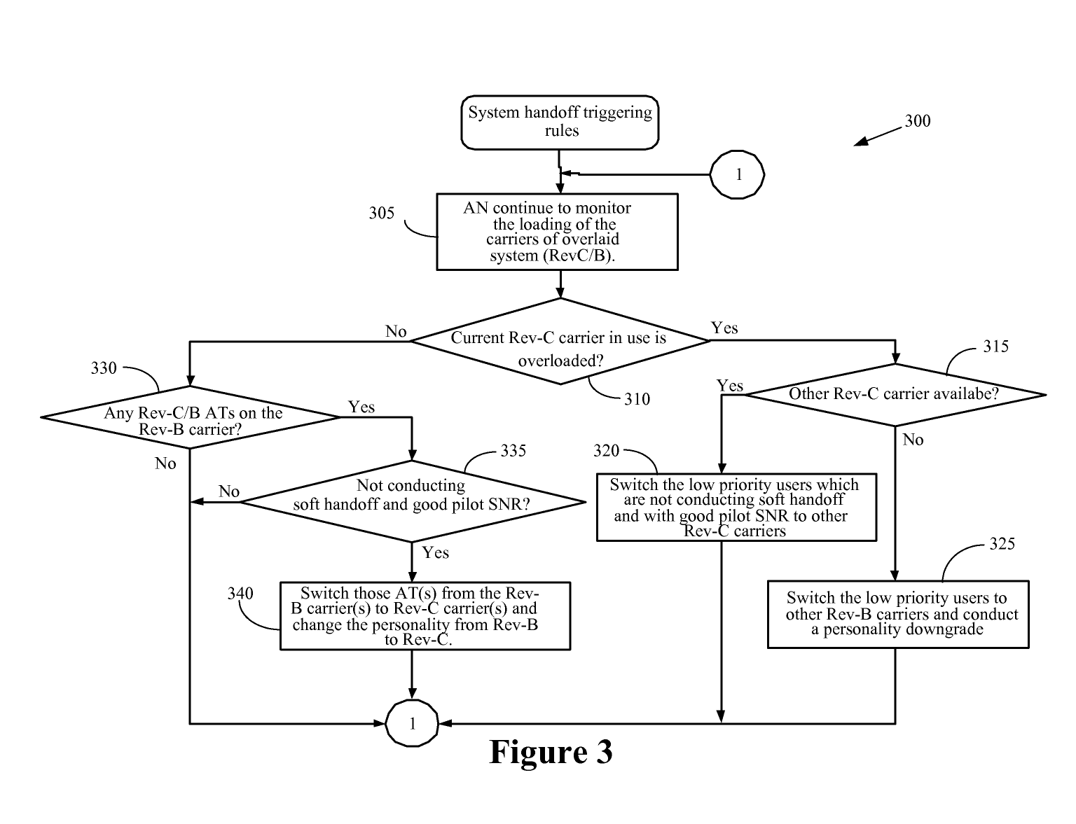

FIG. 3 conceptually illustrates one exemplary embodiment of a method of 300 for handover of a mobile unit. In the illustrated embodiment, one or more access networks (AN) (or constituent base stations) monitor (at 305) loading of carriers associated with overlaid wireless communication systems. For example, the access networks may monitor (at 305) carriers associated with a first layer of cells that operate according to a first system type, such as a most recent revision of a standard or protocol, and carriers associated with a second layer of cells that operate according to a second system type, such as a legacy revision of the standard or protocol. In some embodiments, the first layer and the second layer of cells may cover the same geographic area. If the access network determines (at 310) that a carrier in the first layer of cells, e.g. a Revision-C carrier, is overloaded, and the access network may determine (at 315) whether any other carriers in the first layer of cells are available in the same geographic coverage area.

Mobile units may be handed off (at 320) to the other carriers in the first layer of cells, if the access network determines (at 315) that the other (relatively lightly loaded) carriers are available. For example, relatively low priority users that are not currently in soft handoff and have measured relatively strong pilot signal-to-noise ratios may be directed to hand off to the other carriers. However, if the access network determines (at 315) that no other carriers in the first layer of cells are available, then one or more mobile units may be directed to hand off (at 325) to carriers in the second layer of cells, such as carriers that operate according to legacy standards or protocols such as Revision-B. The mobile units may also conduct (at 325) a personality downgrade in response to being handed off (at 325) to one of the carriers in the second layer of cells.

If the access network determines (at 310) that a carrier in the first layer of cells, e.g. a Revision-C carrier, is not overloaded, then mobile units on other carriers may be handed off to the carrier in the first layer of cells. In the illustrated embodiment, the access network may determine (at 330) whether any other backwards-compatible mobile units (or access terminals, ATs) currently have a communication link over a carrier associated with the second layer of cells, e.g. a Revision-B carrier. If the access network identifies (at 330) an eligible backwards-compatible mobile unit, the access network may determine (at 335) whether the eligible mobile unit is currently in soft handoff and has measured a relatively strong pilot signal-to-noise ratio. If the mobile unit is currently in soft handoff and/or has measured a relatively weak pilot signal-to-noise ratio, then the access network may continue to search (at 330) for other eligible backwards-compatible mobile units.

Eligible backwards-compatible mobile units that are not currently in soft handoff and have measured a relatively strong pilot signal-to-noise ratio may be handed off (at 340) to a carrier in the first layer of cells. For example, eligible backwards-compatible mobile units may be handed off (at 340) to a Revision-C carrier in the first layer of cells from carriers in the second layer of cells, such as carriers that operate according to legacy standards or protocols such as Revision-B. In one embodiment, the personality of the eligible backwards-compatible mobile unit may be changed (at 340) in response to handing off (at 340) the mobile unit to the carrier in the first layer of cells.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of wireless communication involving at least one first carrier operating according to a first system type and at least one second carrier operating according to a second system type, comprising:
determining that a mobile unit is to be handed over between a first carrier operating according to the first system type and a second carrier operating according to the second system type based on a loading of at least one of the first and second carriers.

2. The method of claim 1, wherein determining that the mobile unit is to be handed over comprises determining that the mobile unit is to be handed over between a first carrier operating according to a first standard or protocol revision and a second carrier operating according to a second standard or protocol revision.

3. The method of claim 2, comprising determining a personality change for the mobile unit in response to determining that the mobile unit is to be handed over between the first carrier operating according to the first standard or protocol revision and the second carrier operating according to the second standard or protocol revision.

4. The method of claim 2, wherein determining that the mobile unit is to be handed over comprises determining whether the first carrier is overloaded for a given mobile unit priority class.

5. The method of claim 4, comprising determining whether a third carrier operating according to the first standard or protocol revision is available in response to determining that the first carrier is overloaded.

6. The method of claim 5, comprising determining that the mobile unit is to be handed over from the first carrier to the second carrier in response to determining that the third carrier is not available.

7. The method of claim 6, wherein determining that the mobile unit is to be handed over comprises determining that the mobile unit is to be handed over from a first carrier operating according to a most recent standard or protocol revision to a second carrier operating according to a legacy standard or protocol revision.

8. The method of claim 5, comprising determining that the mobile unit is to be handed over from the first carrier to the third carrier in response to determining that the third carrier is available.

9. The method of claim 8, wherein determining that the mobile unit is to be handed over from the first carrier to the third carrier comprises determining that the mobile unit is to be handed over in response to determining that the mobile unit is not in soft handover and determining that a signal-to-noise ratio is above a predetermined threshold.

10. The method of claim 4, comprising determining whether the mobile unit has a communication link with a second carrier operating according to the second standard or protocol revision in response to determining that the first carrier is not overloaded.

11. The method of claim 10, wherein determining that the mobile unit is to be handed over comprises determining that the mobile unit is to be handed over from the second carrier operating according to a legacy standard or protocol revision to the first carrier operating according to a most recent standard or protocol revision in response to determining that the first carrier is not overloaded.

12. The method of claim 10, wherein determining that the mobile unit is to be handed over comprises determining that the mobile unit is to be handed over in response to determining that the mobile unit is not in soft handover and determining that a signal-to-noise ratio is above a predetermined threshold.

13. The method of claim 10, wherein determining whether the mobile unit has a communication link with the second carrier comprises determining whether the mobile unit has a communication link with the second carrier in response to the mobile unit being handed over from a fourth carrier to the second carrier.

14. The method of claim 1, wherein determining that the mobile unit is to be handed over comprises determining that the mobile unit is to be handed over based on a priority associated with the mobile unit.

15. The method of claim 1, comprising handing the mobile unit over between the first carrier and the second carrier.
